(19) United States
(12) Patent Application Publication
(10) Pub. No.: US 2010/0192460 A1
(43) Pub. Date: Aug. 5, 2010

(54) Stressed Skin Structure for elevated raised bed horticulture

(76) Inventors: DAVID D. HART, Temecula, CA (US); Kenneth Sheppard, Kailua-Kona, HI (US); Ernie Abdon, San Diego, CA (US)

Correspondence Address: David D. Hart, 43395 Corte Durazo, Temecula, CA, 92592, US

(21) Appl. No.: 12/695,873

(22) Filed: Jan. 28, 2010

Related U.S. Application Data
(60) Provisional application No. 61/148,452, filed on Jan. 30, 2009.

(51) Int. Cl. A01G 9/02

(52) U.S. Cl. 47/65.7; 47/65.5; 47/79

(57) ABSTRACT

An economical self supporting structure for holding soil or other growing medium above ground level that allows the user to cultivate plants for consumption or decorative purposes. This design is based on the engineering principle that a circular thin wall structure can contain fluid media without external supports. The outward pressure of the growing medium (soil) inside the circular structure holds the walls vertical and round thus enabling a minimum amount of structural material making this garden design less costly and easier to construct than traditional rectangular box structures made from wood or similar straight construction materials. Because stakes or other support systems are not required, the self supporting circular design is superior for soil containment and superior for the many accessories which can be added including bean pole “tee pees”, hoop structure for plant support or tents (bird net, shade net or plastic for frost protection), and irrigation systems.

### CROSS-REFERENCE TO RELATED APPLICATIONS

This application claims benefit under 35 USC 119(e) to U.S. provisional application No. 61/148,452, filed Jan. 30, 2009.

### BRIEF DESCRIPTION OF THE DRAWINGS

FIG. 1 is a perspective exploded view of a basic segmented kit assembly according to an embodiment of the present invention;

FIG. 2 is a perspective view showing a corrugated multi panel configuration according to an embodiment of the present invention;

FIG. 3 is a perspective view showing a flat single panel configuration according to an embodiment of the present invention;

FIG. 4 is a plan view of the assembly of FIG. 2;

FIG. 5 is a sectional view taken along line A-A of FIG. 4; and

FIG. 6 is a detail cross-sectional view taken along line B of FIG. 5.

### DETAILED DESCRIPTION

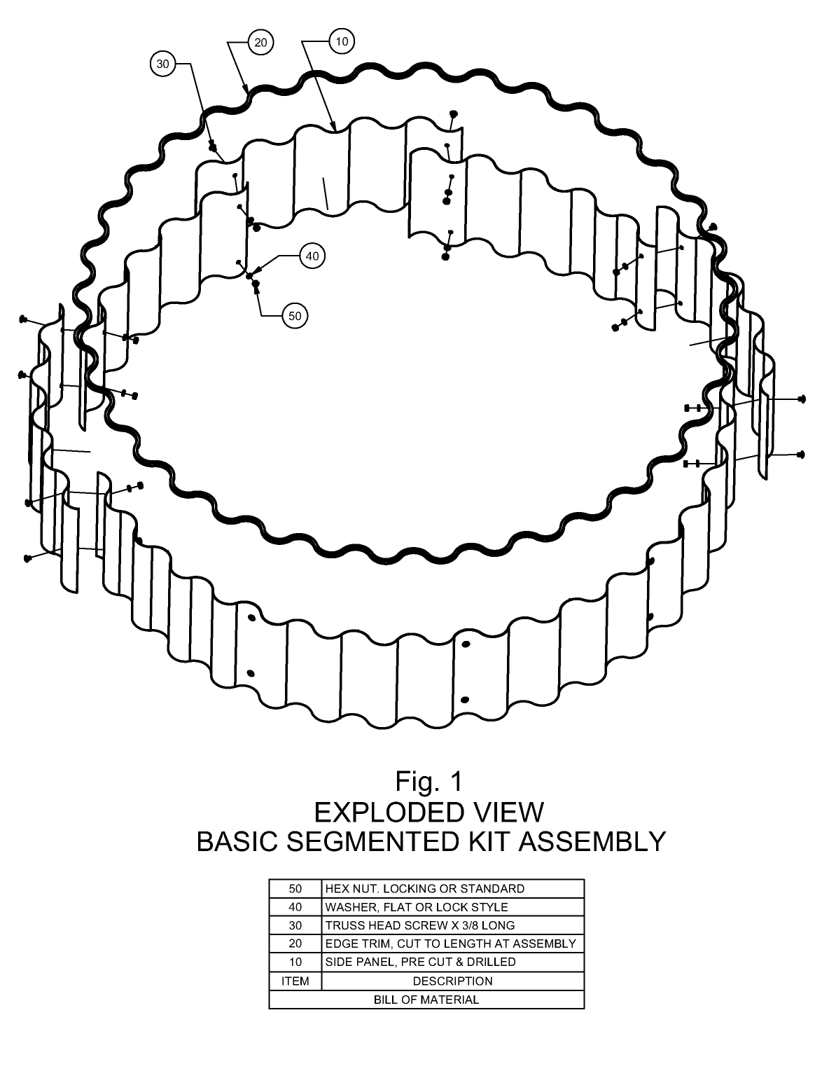

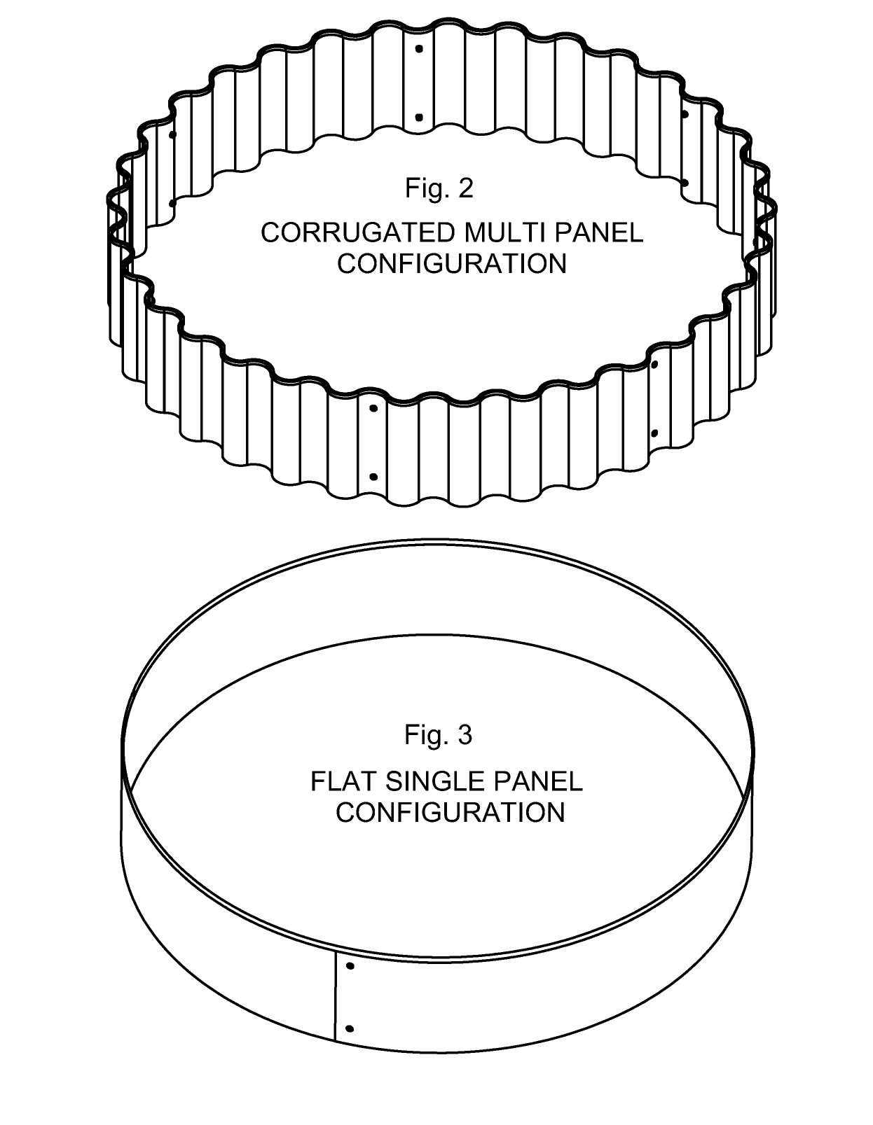

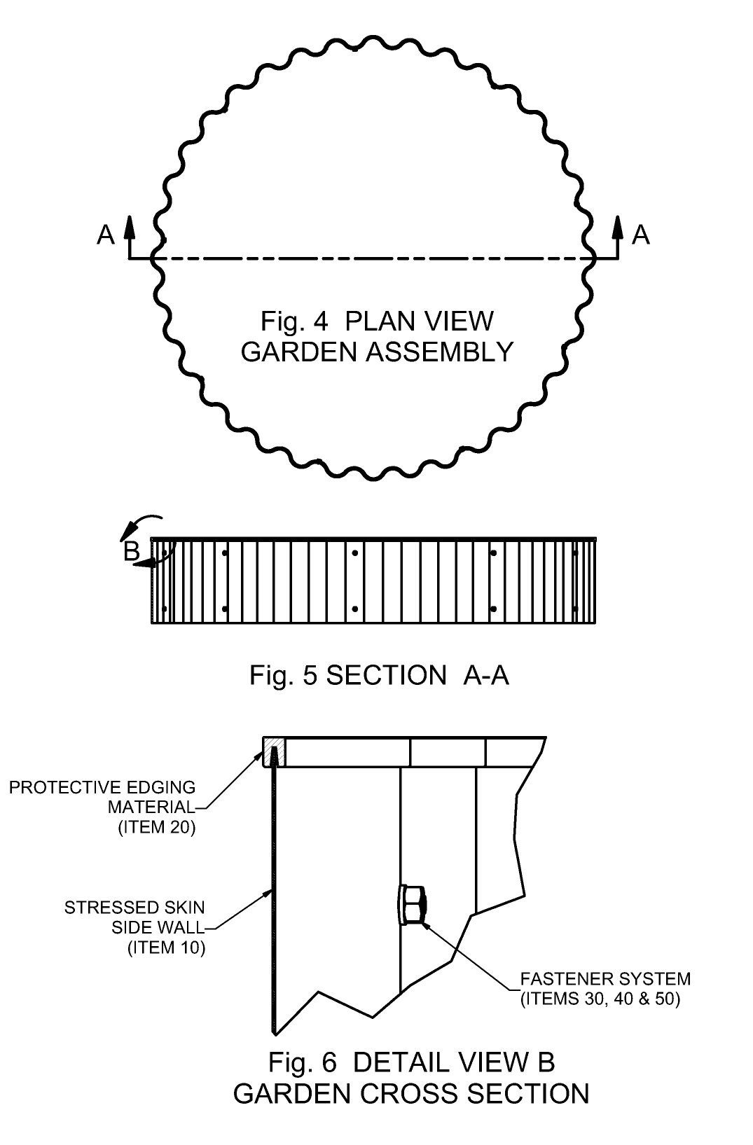

The present invention is a stressed skin structure for elevated raised bed horticulture, which is made up of the following required elements: (1) single or multiple side panels (FIG. 1 item 10); and (2) protective edge guarding (FIG. 1 item 20). These elements are connected together to form a circular shape in the following manner. First the side panels (Item 10) are attached together using threaded fasteners which are passed through pre-punched holes in each panel and held in place with threaded fasteners (FIG. 1 items 30, 40, & 50). The panels (item 10) are attached together to form a continuous loop. The basic circular structure described above is comprised of multiple panels as depicted in FIG. 2 or one single panel as depicted in FIG. 3. The single or multiple panels are both joined together in the same manner as described above. Next, the edge guarding (item 20) is installed on the top edge of the assembled side panels. Further, this invention can also have one or more of the following: (1) a single continuous side wall which is corrugated or flat and joined together at each end to form the circular structure; (2) a pop riveted connection or other means of attachment instead of threaded fasteners, (3) protective edge guarding made from any suitable elastomer or thermoplastic resin either extruded to a specific profile shape or molded to fit the actual edge shape of the stressed skin structure, (4) a painted design or adhesive decal on the side panel for decoration, (5) a galvanized or other electroplated finish for corrosion protection, (6) flexible tubing to carry water for irrigation which is formed to the inside diameter of the circular structure, (7) an integral porous liner to prevent weeds, insects or rodents from entering the garden and (8) a non porous liner to hold water and other liquids in addition to dry media such as soil, to allow the circular structure to act as a storage receptacle for animal feeds, fertilizer or compost. The device is comprised of the following components:
1. A stressed skin side wall (FIG. 1 and FIG. 6, item 10) made from flexible metal, plastic, fiber board, rubber or recycled paper or plastic: The stressed skin side wall forms the vertical walls and is made from thin gauge material that is flexible but not porous. The walls may also include attached or formed stiffening ribs such as corrugations.
2. A fastener system: Mechanical fasteners (FIG. 1 and FIG. 6, items 30, 40, 50) including hex bolts to attach metal skins together. Other means of attachment and joining of panels can include, but are not limited to resistance welding, adhesive bonding, mechanical clips, pop rivets, formed, stamped or molded clips or attachment features in the side panels or any other means of connecting the panels together.
3. Protective Edging: A flexible protective edging (FIG. 1 and FIG. 6, item 20) made from extruded rubber or plastic to act as a protective guard to cover the top edge of vertical wall. Edging material can include, but is not limited to, any flexible material that can form to the profile of the vertical sidewall edge including PVC tubing, vinyl coating or split rubber or elastomer tubing or hose. In addition, the metal edge of the side wall can be mechanically formed over onto itself to create a formed seam to create a rounded edge to achieve the same result of eliminating the sharp cut edge of the side wall. Both the top and bottom edges of the side wall can be covered or mechanically seamed to eliminate the sharp edge and or provide a decorative covering.
4. Environmental Protective Coating: A means to protect the vertical side walls (FIG. 1 and FIG. 6, item 20) from environmental elements is required if steel, aluminum or other suitable metal is used. Electroplating, galvanized coatings for steel, anodized coatings for aluminum, paint and or adhesive labels that provide protection from rust, oxidation, sun fading or typical environmental decay of surface. Decorative coatings will also be applied to achieve the same environmental protection.
5. Irrigation components: Flexible PVC, Polyethylene, Rubber or similar plastic materials and composites to carry and distribute water through spray or drip irrigation means can be integrated into the assembly. This is the preferred method for irrigation.
6. Sun shade to protect sensitive plants: The design supports addition of a polyethylene greenhouse grade cover for climate control of sensitive crops. The climate control sun shade is supported by a pole which is buried in the soil at the center of the garden. The pole rises to a suitable height above the garden to support a fabric or screen material in the center which is then draped over the circular garden. The sun screen can be attached to the perimeter of the garden using hooks, string, or other means to secure it in place. The sun shade can also be supported using a vertical support structure around the perimeter of the garden to provide additional clearance for tall plants.
7. Bird Net or Insect Screen: The design supports addition of a bird net or insect screen to protect fruit or vegetables from birds, animals, or insects including but not limited to flying pest insects such as fruit fly, melon fly and butterflies. The bird net or insect screen is made of fine wire mesh or plastic screen materials and is supported by a center pole which is buried in the soil at the center of the garden. The pole rises to a suitable height above the garden to support a fabric or screen material in the center which is then draped over the circular garden. The perimeter of the screen can be attached to the garden wall with hooks or other suitable means of attachment to secure the protective screen in place.

The metal or plastic skins are joined together with fasteners to form a loop or band. The width of the band can be any convenient height, typically 6 to 18 inches and nominally 11 to 12 inches. Height can be selected for crops requiring different soil depths e.g. leaf crops may be shallow and root crops and vining crops can be deeper to promote optimum plant growth. The assembly is placed on a level surface and oriented in a circular fashion with the walls standing vertical, but unsupported at this point. Dirt or Growing medium (soil) is placed inside the perimeter of the flexible loop until it is filled to a level equal to the height of the vertical walls or just slightly below the top edge by approximately one inch. The outward force of the soil placed inside the perimeter, stresses the metal skin side walls, creating tension which stiffens the side walls creating a free standing container. The protective edging is then placed around the perimeter on the top edge, if necessary, as a protection against any sharp edges. Once filled, with the growing medium evenly distributed, the stressed skin side-wall of the garden takes a stable circular shape and is ready for planting. The invention can be configured with options for irrigation accessories, painted decorations, plant support systems, slug deterrent systems, sun shades or protective covers such as bird nets.

The invention can also be used for holding feed for livestock or any other dry medium that would require short term storage within a confined space. With a suitable liner it can also be used to hold liquids such as water for a stock tank, fish or other aquatic applications.

What is claimed is:

1. A self supporting receptacle for elevated horticulture comprising:
walls supported by an outward force of growing medium placed inside, wherein no other structural supports are required to keep the receptacle erect.

2. The receptacle of claim 1, wherein the walls are formed from an economical metal skin or other type of panel made from extruded plastic resin, formed fiberglass, epoxy or resin over a foam core.

3. The receptacle of claim 1, wherein the receptacle can be used for holding soil or other media for growing plants or be used for storage of compost or liquid media with suitable liner.

4. The receptacle of claim 1, wherein the receptacle is shipped as a kit which the end user assembles with basic hand tools.

5. The receptacle of claim 1, wherein the receptacle is used as a garden, can be accessed easily from all sides given the circular design which allows for equal reach distances to the center of the garden.

6. A circular garden design comprising walls supported by an outward force of growing medium placed inside, wherein no other structural supports are required to keep the receptacle erect, wherein the design is optimum for irrigation and water conservation because water is introduced at outer edges or a perimeter thereof and directed to the center, whereby overspray and waste of water is minimal.

7. The design of claim 6, wherein a configuration of the design is space efficient due to it's circular design which allows spacing of individual gardens in a grid pattern allowing space for a walk way between each garden unit for optimum access.

8. The garden of claim 6, wherein selection of various diameters of the circular design permit different crop uses or other uses, wherein the diameters can be changed by addition or deletion of panels of the circular design.

9. The garden of claim 8, wherein tomatoes may be grown in smaller diameter beds which are deeper than conventional beds.

10. The garden of claim 8, wherein the garden is portable as it can easily be disassembled for storage or be moved and re-erected at a different site.
